(19) United States
(12) Patent Application Publication
(10) Pub. No.: US 2010/0188429 A1
(43) Pub. Date: Jul. 29, 2010

(54) System and Method to Navigate and Present Image Libraries and Images

(75) Inventor: Lee G. Friedman, Alpharetta, GA (US)

Correspondence Address: AT & T LEGAL DEPARTMENT - Toler;ATTN: PATENT DOCKETING, ROOM 2A-207, ONE AT & T WAY, BEDMINISTER, NJ, 07921, US

(73) Assignee: AT&T INTELLECTUAL PROPERTY I, L.P., Reno, NV (US)

(21) Appl. No.: 12/362,115

(22) Filed: Jan. 29, 2009

(51) Int. Cl. G09G 5/00

(52) U.S. Cl. 345/661

(57) ABSTRACT

Methods and systems for navigating and presenting image libraries and images on a display screen are disclosed. A position on a display screen pointed to by a controller is determined. A movement of the controller that changes a distance between the controller and the display screen is detected. A display presented by the display screen is modified by performing a zoom operation related to the determined position on the display screen, where a change in the display based on the zoom operation is determined based on an amount the distance between the controller and the display screen is changed.

### FIELD OF THE DISCLOSURE

The present disclosure is generally related to navigation of images displayed on a display screen.

### BACKGROUND

Industry continues to produce digital cameras with increasing resolution at a decreasing cost. As a result digital cameras have become more popular and consumers may desire to display pictures taken using a digital camera on high-definition television (HDTV) systems. The digital cameras can produce images at resolutions higher than the resolution of the HDTV systems. Consequently, consumers may desire to zoom in and out of images displayed on an HDTV system.

### BRIEF DESCRIPTION OF THE DRAWINGS

FIG. 1 is a block diagram of a particular embodiment of a system to navigate images on a display screen;

FIG. 2 is an illustration of a first particular embodiment of a system to navigate images on a display screen;

FIG. 3 is an illustration of a second particular embodiment of a system to navigate images on a display screen;

FIG. 4 is a diagram illustrating detection of a controller location in three dimensions;

FIG. 5 is an illustration of movement of a controller that changes a distance between the controller and a display screen;

FIG. 6 is an illustration of a change in display as a result of the amount of movement of the controller shown in FIG. 5;

FIG. 7 is an illustration of selecting a focus region using a zoom operation of a particular embodiment of a system to navigate images on a display screen;

FIG. 8 is an illustration of changing a focus region to a selected portion of an image;

FIG. 9 is an illustration of a change in display as a result of a zoom operation applied to the display shown in FIG. 8;

FIG. 10 is an illustration of selecting a portion of an image presented by a display screen;

FIG. 11 is a flow chart of a first particular embodiment of a method of navigating images presented on a display screen;

FIG. 12 is a flow chart of a second particular embodiment of a method of navigating images presented on a display screen; and

FIG. 13 depicts an illustrative embodiment of a general computer system.

### DETAILED DESCRIPTION

Systems and methods of navigating images on a display screen are disclosed. In a first particular embodiment, a first method of navigating images on a display screen is disclosed. The first method includes determining a position on a display screen pointed to by a controller. The first method also includes detecting a movement of the controller that changes a distance between the controller and the display screen. A display presented by the display screen is modified by performing a zoom operation related to the determined position on the display screen. A change in the display based on the zoom operation is determined based on an amount the distance between the controller and the display screen is changed.

In a second particular embodiment, a second method of navigating images on a display is disclosed. The second method includes receiving a position on a display screen from a controller. The second method also includes receiving from the controller an amount a distance between the controller and the display screen has changed. A display presented by the display screen is modified by performing a zoom operation related to the determined position on the display screen. A change in the display based on the zoom operation is determined based on the amount the distance has changed.

In a third particular embodiment, a computer-readable storage medium is disclosed. The computer-readable storage medium includes computer-executable instructions that, when executed, cause a processor to perform operations including determining a position on a display screen pointed to by a controller. The operations also include detecting a movement of the controller that changes a distance between the controller and the display screen. The operations further include modifying a display presented by the display screen by performing a zoom operation related to the determined position on the display screen, wherein a change in the display based on the zoom operation is determined based on an amount the distance between the controller and the display screen is changed.

In a fourth particular embodiment, a system for navigating images on a display screen is disclosed. The system includes a detector, a position-determining module, a movement-detection module, and a display module. During operation, the detector detects a position of a first LED module and a second LED module relative to the detector. The first LED module and the second LED module are located at a controller and are a predetermined distance from each other. The position-determining module determines a position on a display screen pointed to by the controller based on the position of the first LED module and the position of the second LED module. The movement-detection module detects a movement of the controller that changes a distance between the controller and the display screen. The display module modifies a display presented by the display screen by performing a zoom operation related to the determined position on the display screen, wherein a change in the display based on the zoom operation is determined based on an amount the distance between the controller and the display is changed.

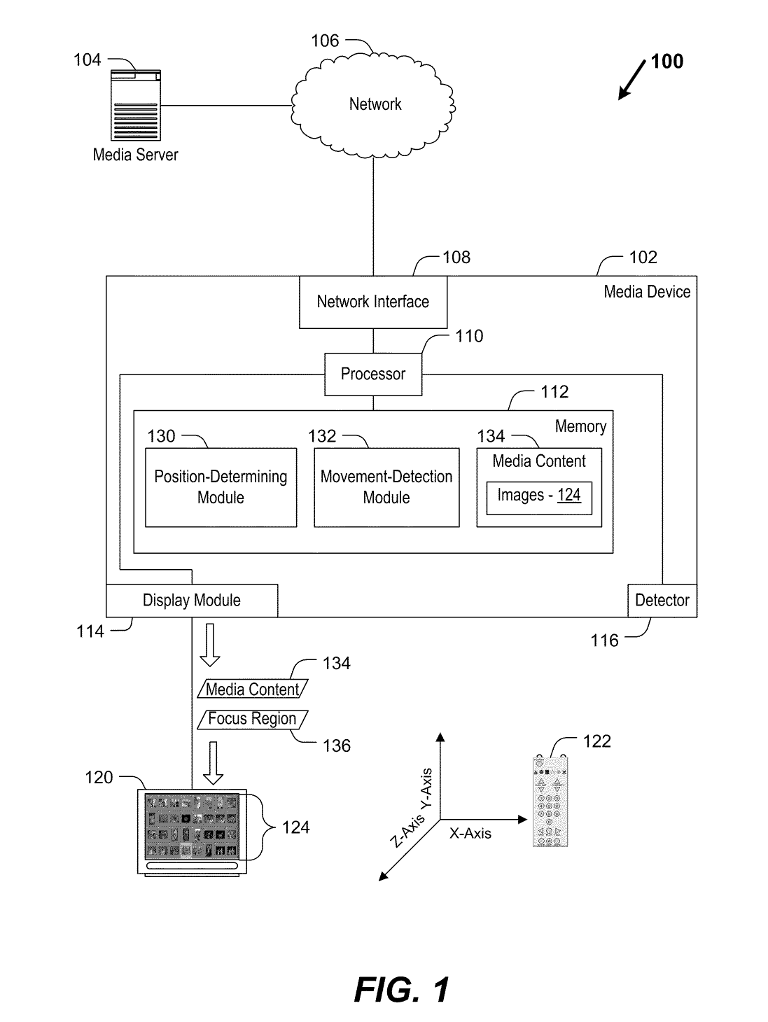

Referring to FIG. 1 an illustrative embodiment of a system 100 to provide navigation of images on a display screen 120 is disclosed. The system 100 includes a media device 102 connected to a network 106. The network 106 provides the media device 102 with access to a media server 104. The media device 102 is also connected to the display screen 120. The media device 102 can communicate with a controller 122.

The media device 102 includes a network interface 108 that enables the media device 102 to connect to the network 106, providing the media device 102 with access to the media server 104. The media device 102 also includes a processor 110, a display module 114 accessible to the processor 110, a detector 116 accessible to the processor 110, and a memory 112 accessible to the processor 110. The memory 112 includes a position-determining module 130, a movement-detection module 132, and media content 134. The position-determining module 130 includes instructions, executable by the processor 110, to enable the media device 102 to determine a position on the display screen 120 point to by the controller 122. The movement-detection module 132 includes instructions, executable by the processor 110, to detect a movement of the controller 122 that changes a distance between the controller 122 and the display screen 120.

During operation, a user (not shown) may use the controller 122 to point to the display screen 120. The position-determining module 130 determines a position on the display screen 120 pointed to by the controller 122. The display module 114 presents images on the display screen 120. For example, the display module 114 may display the media content 134 on the display screen 120. In particular embodiments, the media device 102 receives the media content 134 from the media server 104 and the display module 114 displays the media content 134 on the display screen 120. The display module 114 may also indicate a selected focus region 136 on the display screen 120. The focus region 136 may be a portion of an image displayed on the display screen 120 to which an operation (e.g., a zoom operation) is to be applied. In particular embodiments, the focus region 136 is indicated as a highlighted portion of an image displayed on the display screen 120. In particular embodiments, the focus region is indicated as a cursor displayed on the display screen 120. The focus region may also be indicated as an outline, such as a rectangular outline indicating a portion of a display on the display screen 120. A user may point the controller 122 at the display screen 120 to select a portion of the display on the display screen 120 on which to perform a zoom operation. The user may cause the zoom operation to be performed by moving the controller 122 either closer to the display screen 120 or further away from the display screen 120. That is, the user may move the controller 122 an amount along a z-axis, where the z-axis is substantially perpendicular to the display screen 120. The movement-detection module 132 may detect a movement of the controller that changes a distance between the controller 122 and the display screen 120. The display module 114 then modifies the display on the display screen 120 by performing a zoom operation related to the position on the display screen 120 pointed to by the controller 122. The change in the display is based on the zoom operation. The zoom operation is determined based on an amount the distance between the controller 122 and the display screen 120 is changed.

The media device 102 allows a user to quickly navigate media content 134, such as images 124 displayed on the display screen 120, in three dimensions. For example, the user may easily navigate through pages of images by zooming in on the current page displayed to cause the next page to be displayed. The user may then select a particular image on the page of images currently displayed by pointing to the particular image with the controller 122. The selected image can then be enlarged or zoomed in on by moving the controller 122 closer to the display screen 120 to perform a zoom operation.

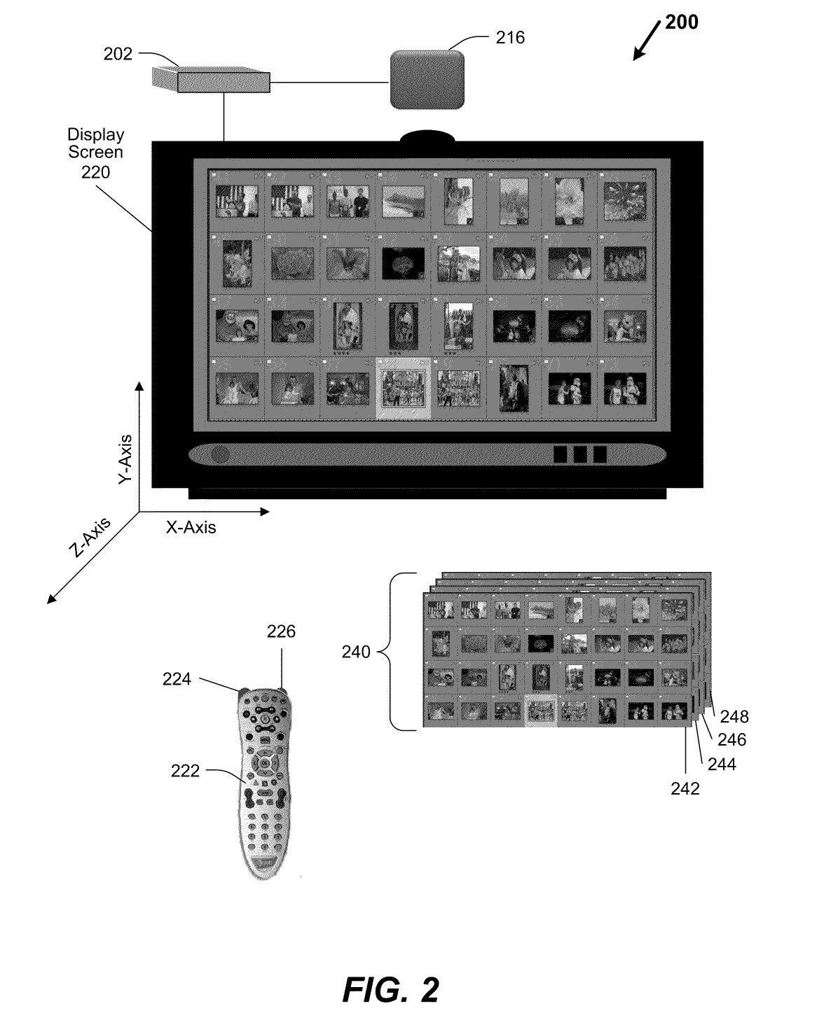

Referring to FIG. 2, an illustrative first particular embodiment of a system 200 to navigate images presented on a display screen 220 is disclosed. The system 200 includes the display screen 220, a set top box 202, a detector 216, and a controller 222. In particular embodiments, the set top box 202 includes the display module 114, the processor 110, the memory 112, the position-determining module 130, and the movement-detection module 132 of the media device 102 shown in FIG. 1. The controller 222 includes a first LED module 224 and a second LED module 226. The first LED module 224 and the second LED module 226 are a predetermined distance apart. In particular embodiments, the detector 216 detects positions of the first LED module 224 and the second LED module 226 relative to the detector 216 along an x-axis and a y-axis, where the x-axis and the y-axis are substantially parallel to the display screen 220 and the x-axis is perpendicular to the y-axis. The set top box 202 may determine a position on the display screen 220 pointed to by the controller 222 based on the detected positions of the first LED module 224 and the second LED module 226.

In particular embodiments, the detector 216 is placed close to the display screen 220, such as immediately above the display screen 220 or immediately below the display screen 220, for example. In this manner, when a user moves the controller 222 closer to the display screen (e.g., closer to an image on the display screen 220 pointed to by the controller 222) the detector 216 will detect the movement of the controller 222 as movement closer to the detector 216.

During operation, a user may navigate through images that the system 200 retrieves from an image library. In particular embodiments, the image library is stored at a database accessible to the system 200. In a particular embodiment, the display screen displays a first collection of selectable images prior to a zoom operation and the display presented by the display screen includes a second collection of selectable images after the zoom operation. The collections of selectable images may be displayed as pages of images. In particular embodiments, a user may navigate through a sequence of pages 240 of images. For example, if the user does not find an image of interest on a first page 242, the user may perform a zoom operation by moving the controller 222 closer to the display screen 220 causing the set top box 202 to change the display by displaying a subsequent page 244 of images in the sequence of pages 240. The user may also reverse this operation by moving the controller 222 further away from the display screen 220 causing the set top box 202 to zoom out to an earlier page in the sequence of pages 240. For example, when a fourth page 248 of images is displayed on the display screen 220, the user may move the controller 222 further away from the display screen 220 (i.e., movement along the z-axis) to display the other pages 246, 244, or 242 of images, for example. In this manner, the user can quickly view the images on the sequence of pages 240 of images.

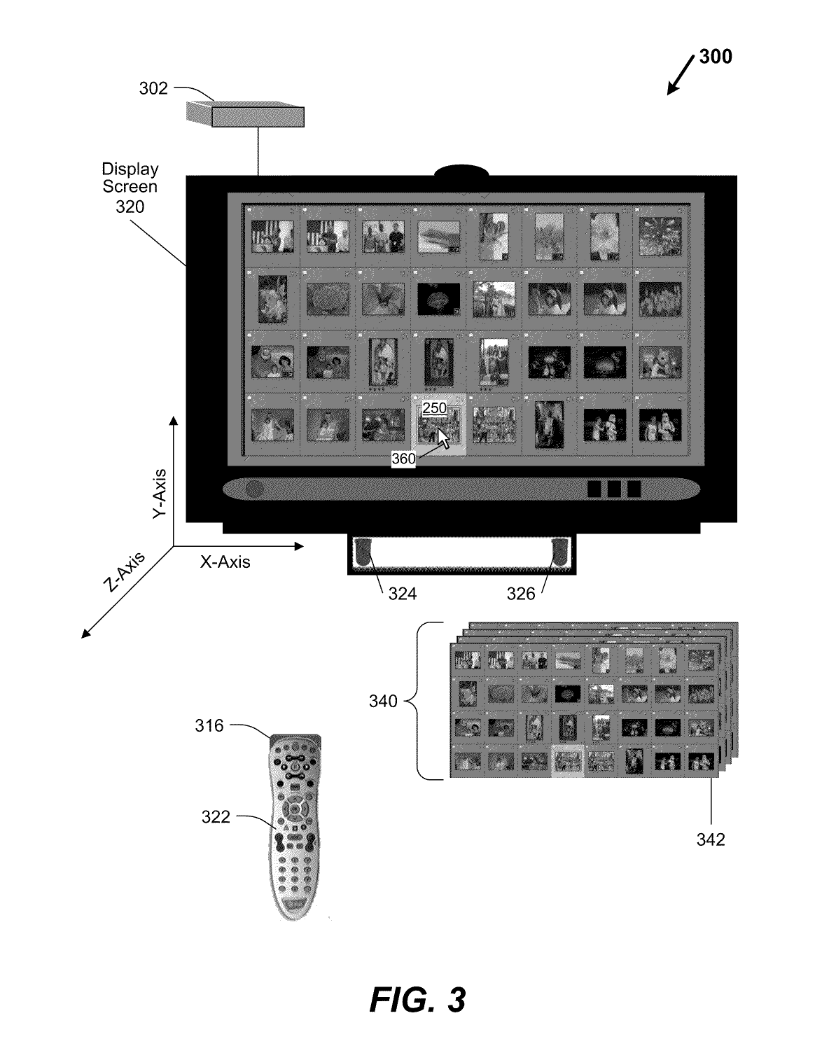

Referring to FIG. 3, an illustration of a second particular embodiment of a system 300 to navigate images on a display screen is disclosed. The system 300 includes a set top box 302, a display screen 320, a controller 322, a first LED module 324 and a second LED module 326. The controller 322 includes a detector 316. The first LED module 324 and the second LED module 326 are a predetermined distance apart. The first LED module 324 and the second LED module 326 are stationary and are placed near the display screen 320. The detector 316 detects positions of the first LED module 324 and the second LED module 326 relative to the detector 316. For example, a user may move the controller 322 from side to side (i.e., from left to right and right to left) or may move the control up and down while operating the controller 322. The detector 316 may detect positions of the controller 322 as it is moved side to side as positions along an x-axis substantially parallel to the display screen 320. The detector 316 may detect positions of the controller 322 as it is moved up and down as positions along a y-axis substantially parallel to the display screen 320, where the x-axis is perpendicular to the y-axis. In a particular embodiment, the controller 322 then communicates these detected positions to the set top box 302. The set top box 302 can determine a position on the display screen 320 pointed to by the controller 322 based on the detected positions communicated to the set top box 302. In another particular embodiment, the controller 322 determines a position on the display screen 320 pointed to by the controller 322 based on the detected positions and communicates the determined position on the display screen 320 to the set top box 302.

A user may navigate through a sequence of pages 340 of images by moving the controller 322 closer to the display screen 320 or further away from the display screen 320. The user may highlight a particular image, for example a first image 250 on a first page 342 of images by pointing to the first image 250 with the controller 322. In particular embodiments, a cursor 360 is displayed on the display screen 320 to indicate to a user the position on the display screen 320 pointed to by the controller 322. The display screen 320 may also highlight the first image 250 to indicate that the controller 322 is pointing to the first image 250.

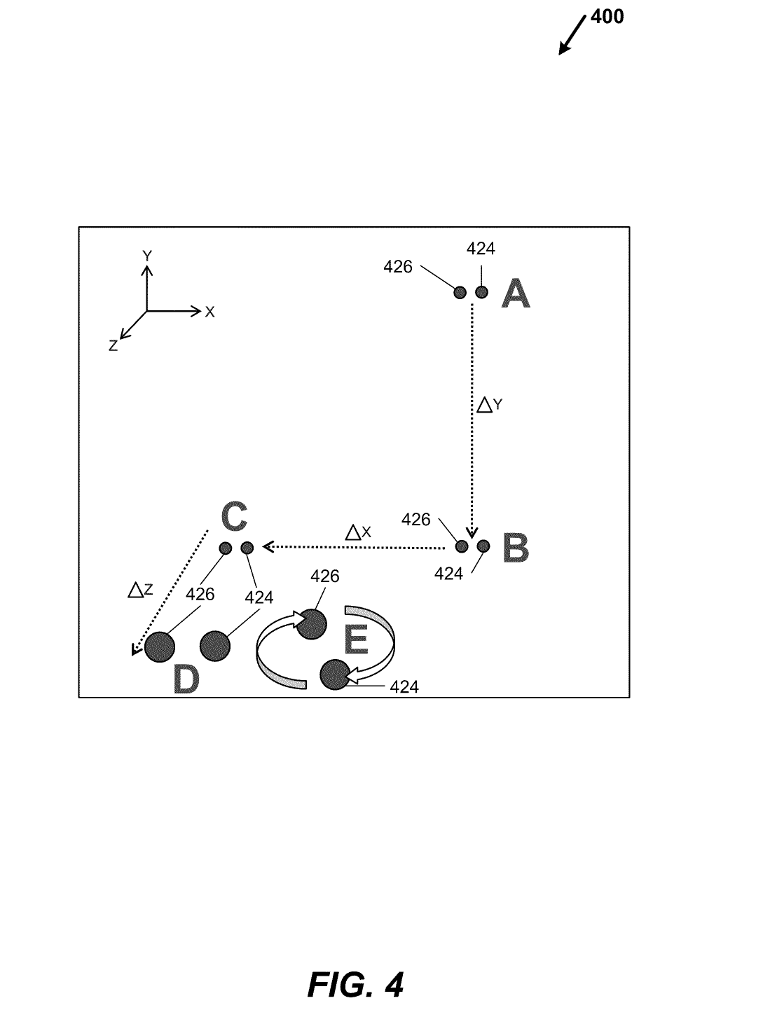

Referring to FIG. 4, a diagram 400 illustrating detection of a controller location in three dimensions is disclosed. The diagram 400 shows a first LED module 424 and a second LED module 426 of a controller (not shown) as detected by a detector (not shown). The first LED module 424 and the second LED module 426 may be the first LED module 224 and the second LED module 226 discussed with respect to FIG. 2, for example. In another example, the first LED module 424 and the second LED module 426 may be the first LED module 324 and the second LED module 326 discussed with respect to FIG. 3.

At position A, the detector detects a first position of the first LED module 424 and the second LED module 426. At position B, the detector detects a second position of the first LED module 424 and the second LED module 426. By comparing position A and position B, a change in the position of the controller along a y-axis (ΔY) on a display screen can be determined. Similarly, a change in the position of controller along an x-axis (ΔX) of the display screen can be determined by comparing position B with position C. At position D, the first LED module 424 and the second LED module 426 have been moved closer to the display screen causing the first LED module 424 and the second LED module 426 to appear larger, brighter and farther apart than they appeared at position C. By comparing the first LED module 424 and the second LED module 426 at position C with the first LED module 424 and the second LED module 426 at position D, an amount of movement of the controller along a z-axis (ΔZ) can be determined. The z-axis is substantially perpendicular to the display screen 220. Accordingly, movement of the controller along the z-axis changes the distance between the controller and the display screen. By comparing the first LED module 424 and the second LED module 426 at position E with the first LED module 424 and the second LED module 426 at position D, an amount of rotation around the z-axis can be determined. In particular embodiments, a user may rotate the controller around the z-axis in order to instruct a set top box to rotate a selected image on the display screen.

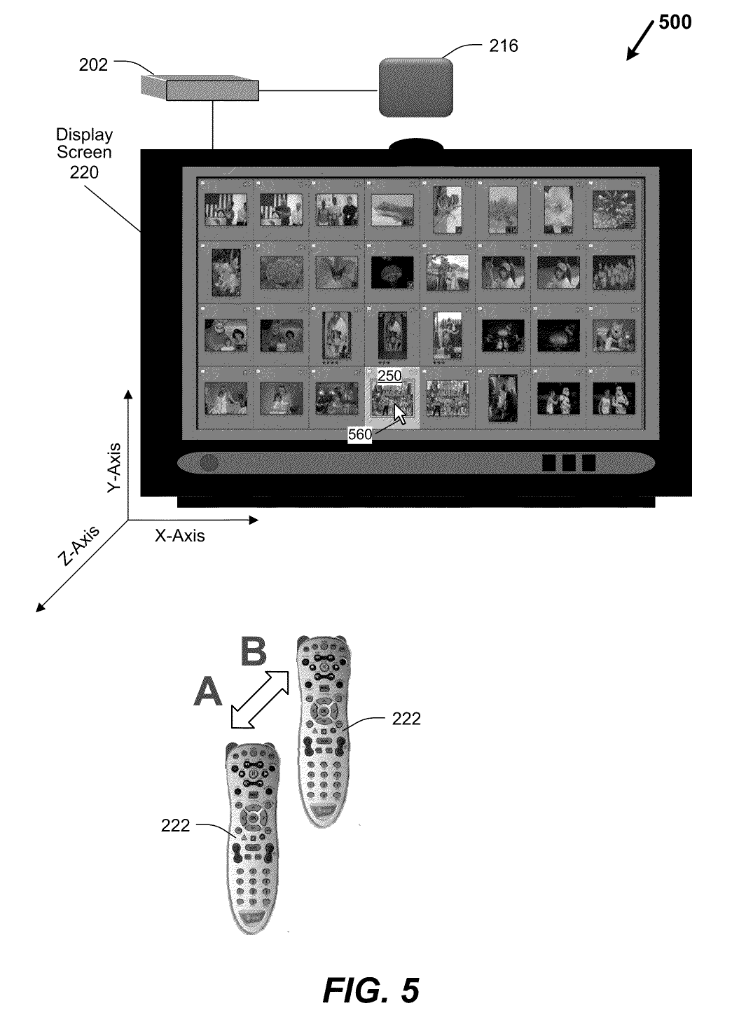

Referring to FIG. 5, an illustration 500 of a movement of the controller 222 that changes a distance between the controller 222 and the display screen 220 is disclosed. The user has selected the highlighted image 250 by pointing to a position on the display screen 220 indicated by a cursor 560 displayed on the display screen 220. The user may perform a zoom operation on the highlighted image 250 by moving the controller 222 from position A to position B. That is, the user may perform the zoom operation by moving the controller 222 closer to the display screen 220. In particular embodiments, the user will indicate the desire for a zoom operation to be performed on the highlighted image 250 by depressing a particular button (e.g., a “zoom” button) on the controller 222 while moving the controller 222 from position A to position B. The detector 216 may detect the amount of movement of the controller 222 along the z-axis in the manner discussed with respect to FIG. 4.

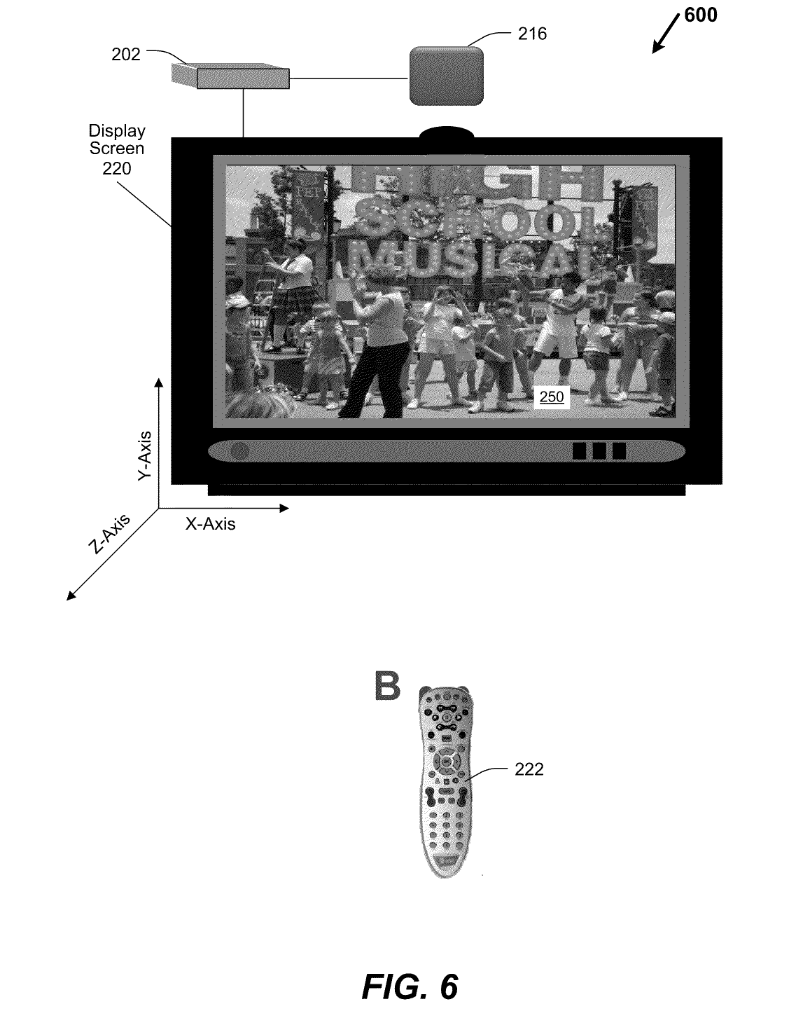

Referring to FIG. 6, an illustration 600 of a change in display as a result of the movement of the controller 222 shown in FIG. 5 is disclosed. Specifically, the user has moved the controller 222 closer to the display screen 220 (e.g., from position A to position B as discussed with respect to FIG. 5), causing the image 250 to be zoomed in on or enlarged.

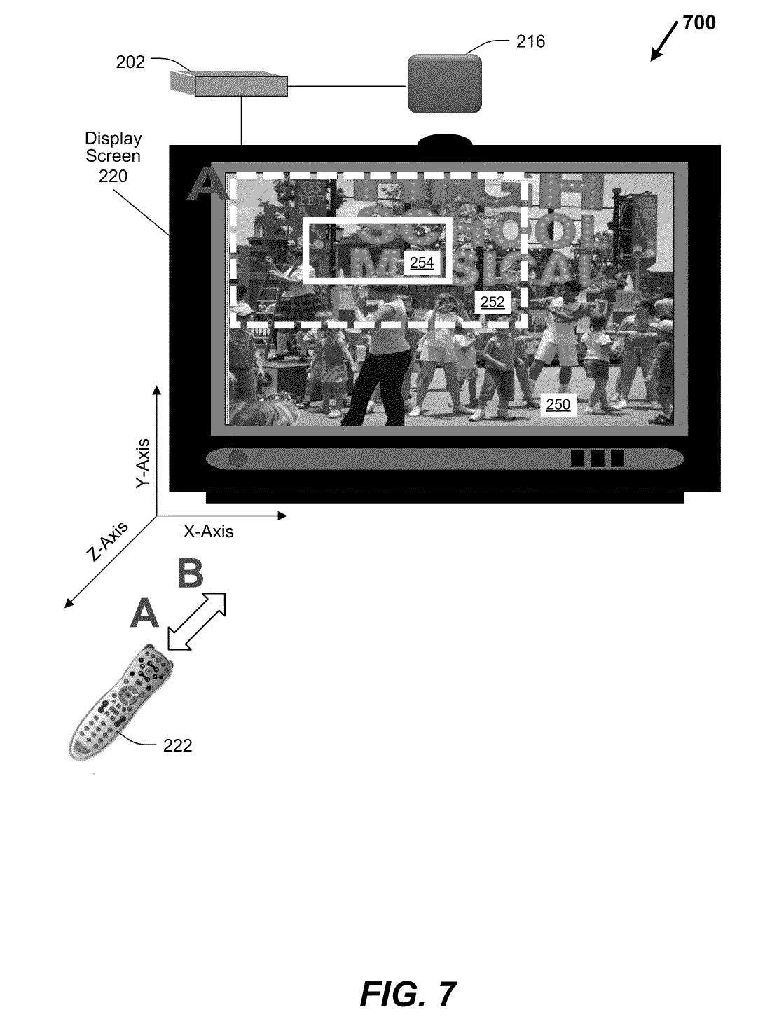

Referring to FIG. 7, an illustration 700 of selecting a focus region using a zoom operation of a particular embodiment of a system to navigate images on a display screen 220 is disclosed. In FIG. 7, a first focus region 252 (indicated by a dotted line) is associated with position A of controller 222. In particular embodiments, a user may change to a second focus region 254 (indicated by a solid line) by moving the controller 222 from position A to position B. In particular embodiments, the user will depress a particular key or button on the controller 222 to indicate a desire to change the size of the focus region based on the movement of the controller 222. The set top box 202 detects that the change in position A to position B is a movement along the z-axis and performs a zoom operation with the zoom operation changing from the first focus region 252 to the second focus region 254. In particular embodiments, the amount of change in size of the first focus region 252 to the second focus region 254 is based on a determined amount of movement of the controller 222 along the z-axis. In particular embodiments, the display screen 220 has a rectangular shape having a particular aspect ratio and the first focus region 252 and the second focus region 254 have aspect ratios substantially the same as the particular aspect ratio of the display screen 220. Thus, changing the size of a focus region may not change the shape of the focus region.

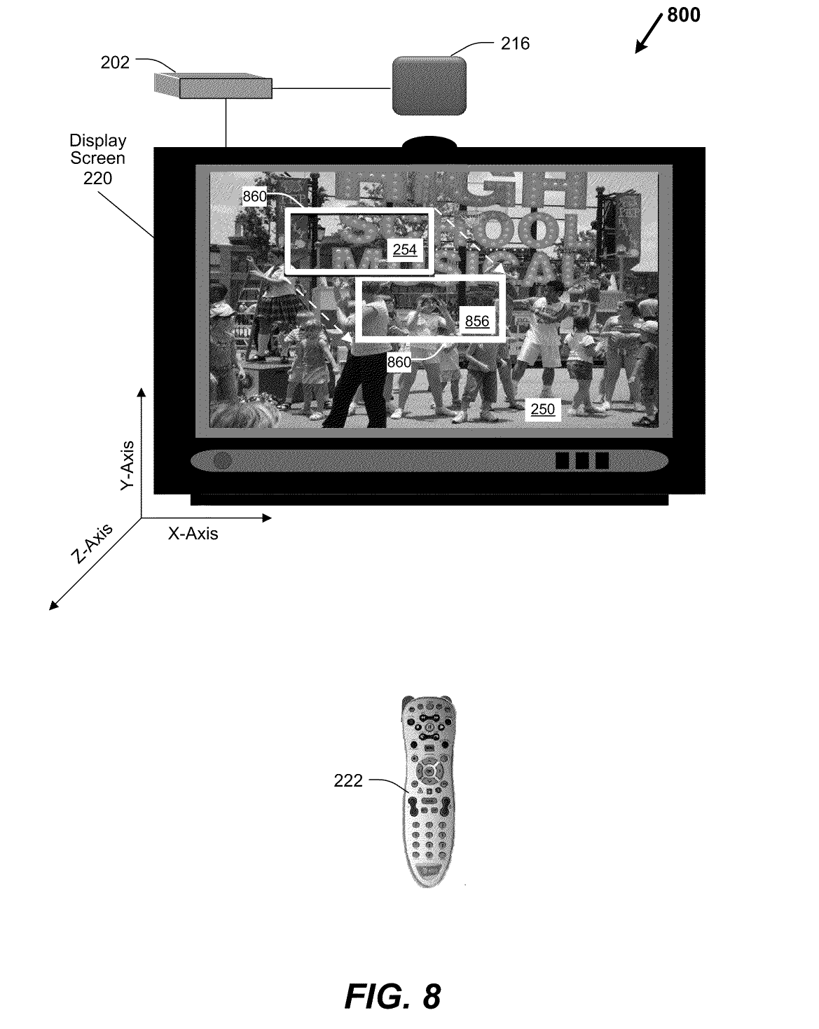

Referring to FIG. 8, an illustration 800 of changing the focus region 254 to a selected focus region 856 of an image 250 is shown. The user may change the focus region 254 to a selected focus region 856 of the image 250 which the user wishes to zoom in on or enlarge. In particular embodiments, the user may move a focus region indicator 860 by pointing to the focus region 254 with the controller 222 and pressing a particular button on the controller 222 (e.g., a “select” button or a “move” button) while moving the controller 222 to position the focus region indicator 860 over the selected portion of image 250 to be enlarged creating a new focus region 856. The user may then enlarge the portion of image 250 selected by the new focus region 856 by moving the controller 222 along the z-axis and closer to the display screen 220. In particular embodiments, the user will depress a particular button, such as a “zoom” button, while moving the controller 222 toward the display screen 220 to perform the zoom operation and enlarge the portion of image 250 determined by the focus region 856.

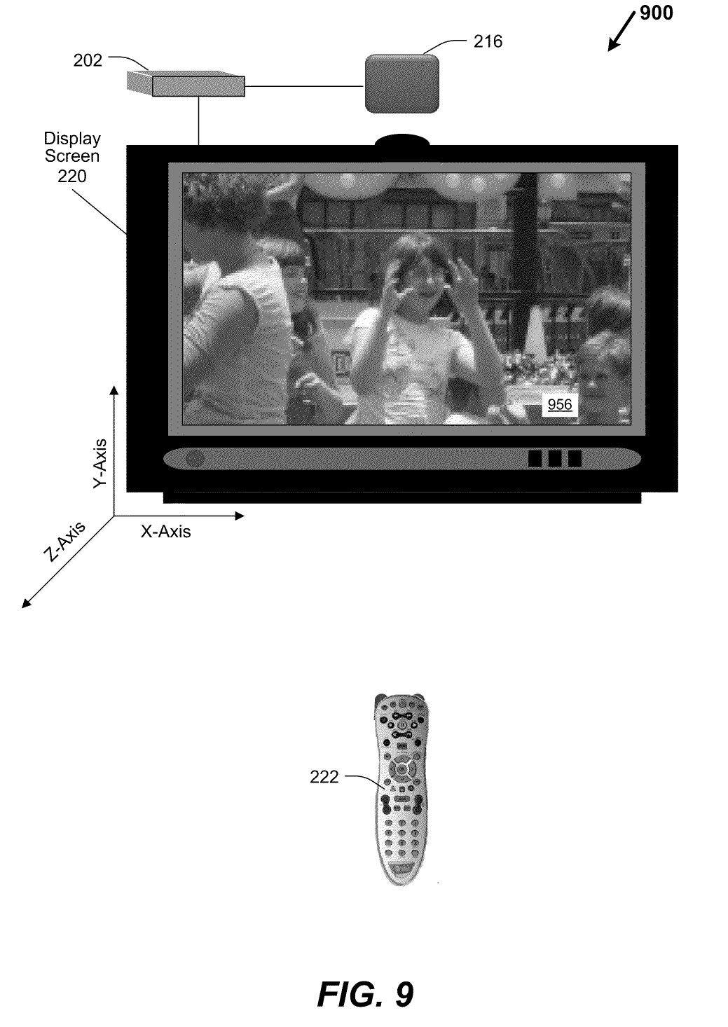

Referring to FIG. 9, an illustration 900 of a change in a display as a result of a zoom operation applied to the display in FIG. 8 is disclosed. That is, FIG. 9 shows an image 956 created as a result of applying a zoom operation to the focus region 856 shown in FIG. 8. In particular embodiments, the zoom operation is performed when the user moves the controller 222 closer to the display screen 220 while depressing a “zoom” button.

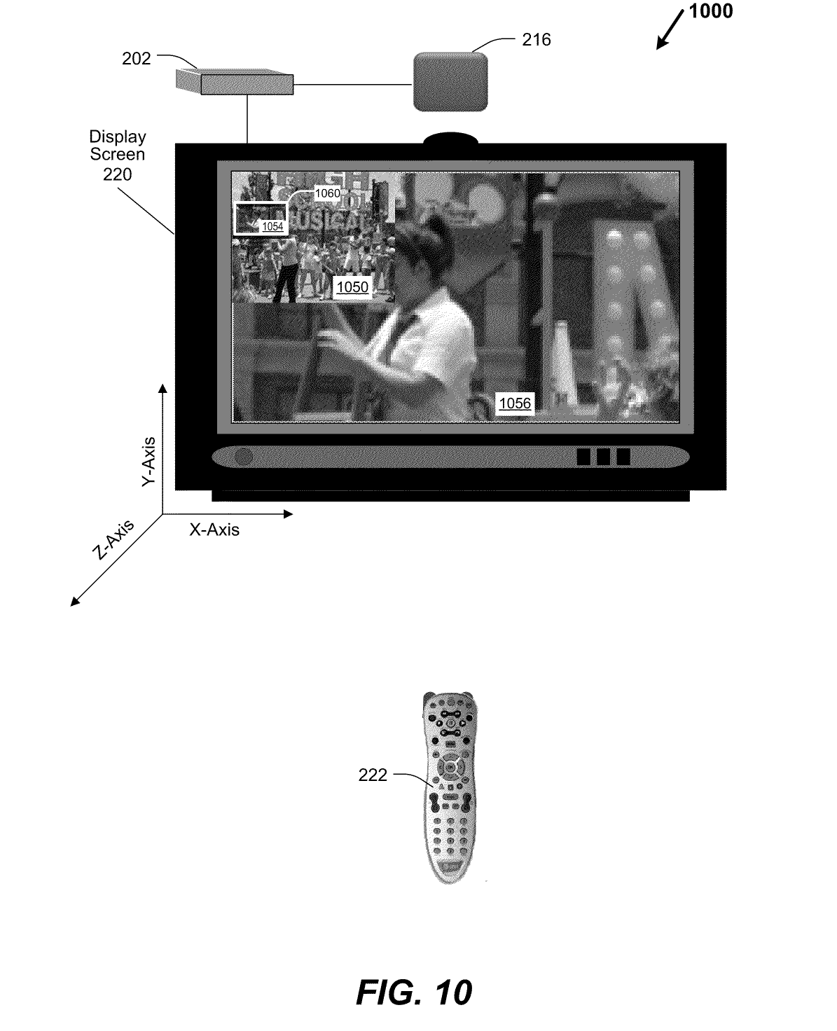

Referring to FIG. 10, an illustration 1000 of selecting and enlarging a portion of an image 1050 presented by a display screen 220 is disclosed. For example, a user may use the controller 222 to move a focus region indicator 1060 within the image 1050 in the same manner as the focus region indicator 860 of FIG. 8 is moved. While the user moves the focus region indicator 1060, the image within the focus region is enlarged and displayed allowing the user to view an enlarged version of a focus region indicated by the focus region indicator 1060 as the focus region indicator is being moved within the image 1050. For example, an image 1054 indicated by the focus region indicator 1060 is enlarged and displayed as image 1056.

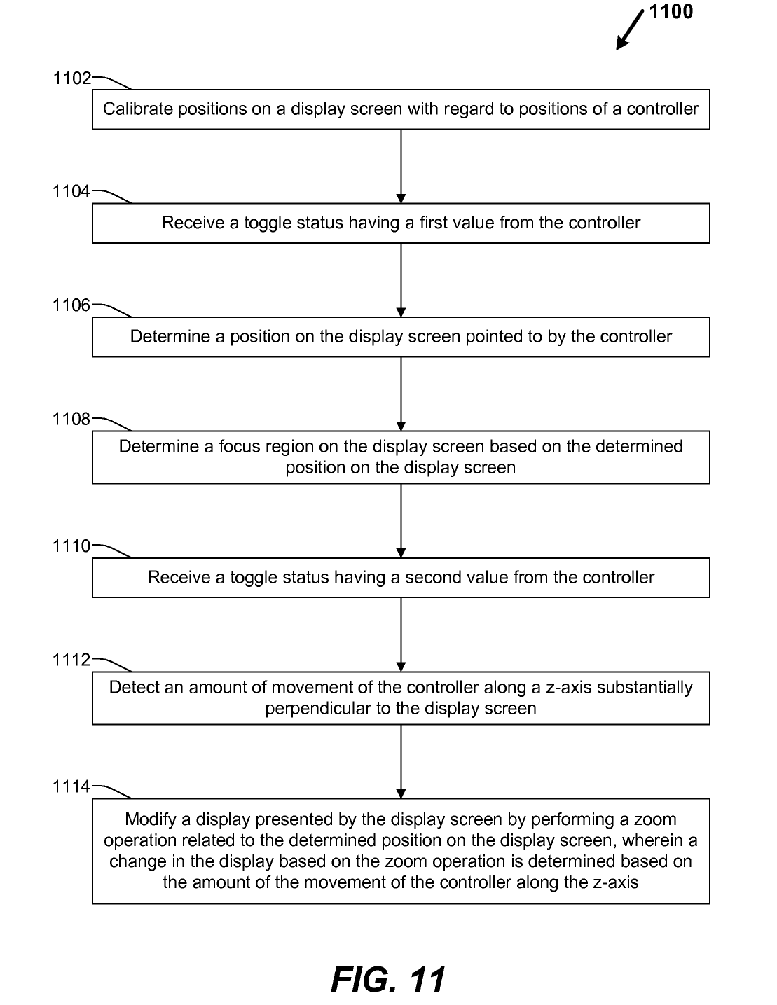

Referring to FIG. 11, a flow chart 1100 of a first particular embodiment of a method of navigating images presented on a display screen is disclosed. At 1102, a system calibrates positions on a display screen with regard to positions of a controller. In particular embodiments, the system calibrates the positions by displaying a plurality of objects (e.g., a crosshair) on the display screen and having a user of the controller point to each object and depress a particular button (e.g., a “select” button) on the controller.

Advancing to 1104, the method includes receiving a toggle status having a first value from the controller. In particular embodiments, the toggle status may indicate whether a position on the display screen is to be determined (e.g., movement along the z-axis is to be ignored) or whether an amount of movement along the z-axis is to be determined (e.g., motion along the x-axis and the y-axis is to be ignored). For example, a user wishing to use the controller to point to an object or a position on the display screen may not want any incidental motion along the z-axis to be recognized and may depress a particular button on the controller to set the toggle status in a first value. This first value of the toggle status may indicate that the user wishes to select a position on the display screen. Advancing to 1106, the method includes determining a position on the display screen pointed to by the controller. A focus region on the display screen is determined based on the determined position on the display screen, at 1108. The focus region on the display screen may be indicated by a cursor, for example. Alternately or in addition to, the focus region of the display screen may be indicated by a rectangular indicator presented on the display screen, such as the focus region indicator 860 of FIG. 8 or the focus region indicator 1060 of FIG. 10. Additionally, the focus region may be a highlighted image of a plurality of images displayed on the display screen.

Advancing to 1110, the method includes receiving a toggle status having a second value from the controller. The second value may be received in response to the user releasing the button which set the toggle status to a first value, for example. Alternately, the second value of the toggle status may be received in response to the user depressing a different button on the controller than the button that was depressed to set the toggle status to the first value. A user can set the toggle status to the second value when an amount of motion along the z-axis is to be detected (e.g., incidental motion along the x-axis or the y-axis is to be ignored). In this manner, an amount of movement of the controller along the z-axis may be detected in order to determine a zoom operation to be performed and any incidental movement along either the x-axis or the y-axis is ignored. Advancing to 1112, an amount of movement of the controller along the z-axis is detected. For example, when the user wishes to zoom in or enlarge a particular object displayed on the display screen or a portion of the image displayed on the display screen, the user may set the toggle status to the second value and move the controller closer to the display screen in order to perform the zoom operation. Alternately, the user may zoom out by moving the controller further away from the display screen.

Advancing to 1114, a display presented by the display screen is modified by performing a zoom operation related to the determined position on the display screen. For example, the zoom operation may be performed on an image selected based on the determined position on the display screen. A change in the display as a result of the zoom operation is determined based on the amount of the movement of the controller along the z-axis. For example, a user may navigate through pages of images displayed on the display screen by moving the controller a particular amount toward the display screen to advance to a next page and by moving the controller an additional amount toward the display screen in order to advance to yet another page.

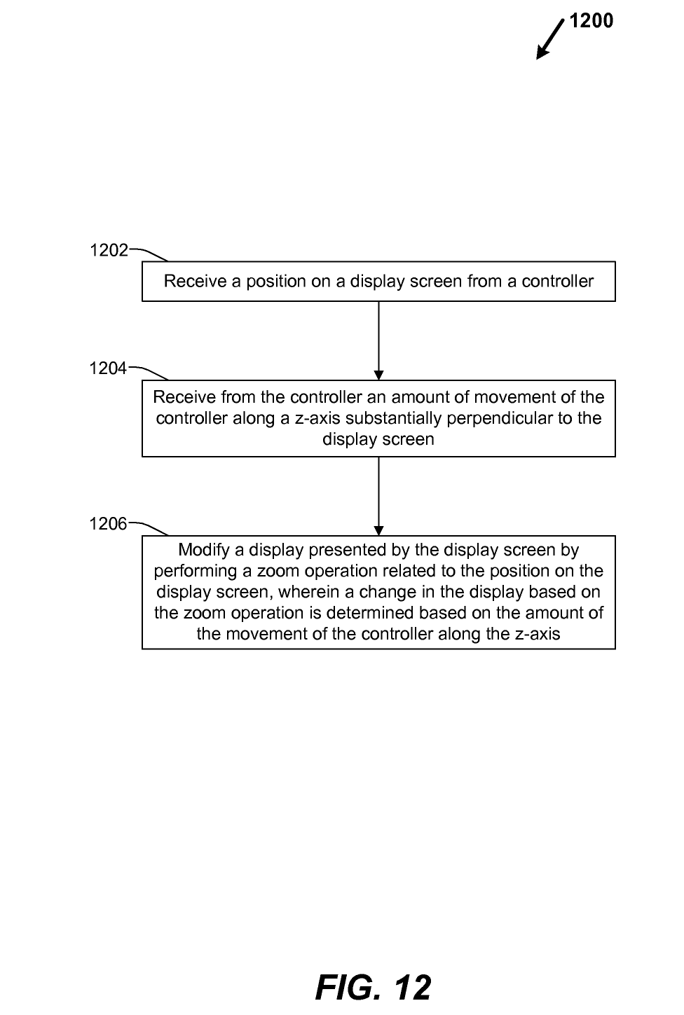

Referring to FIG. 12, a flow chart 1200 of a second particular embodiment of a method of navigating images presented on a display screen is disclosed. The method may be performed by a system where a detector is positioned at a controller, such as the system 300 shown in FIG. 3. A position on a display screen is received from a controller, at 1202. Advancing to 1204, an amount of movement of the controller along the z-axis is received from the controller. For example, when the user moves the controller closer to the display screen, the controller detects an amount of movement of the controller 322 along the z-axis, and may transmit the detected amount of movement to a set top box.

Advancing to 1206, a display presented by the display screen is modified by performing a zoom operation related to the position on the display screen. A change in the display based on the zoom operation is determined based on the amount of the movement of the controller along the z-axis.

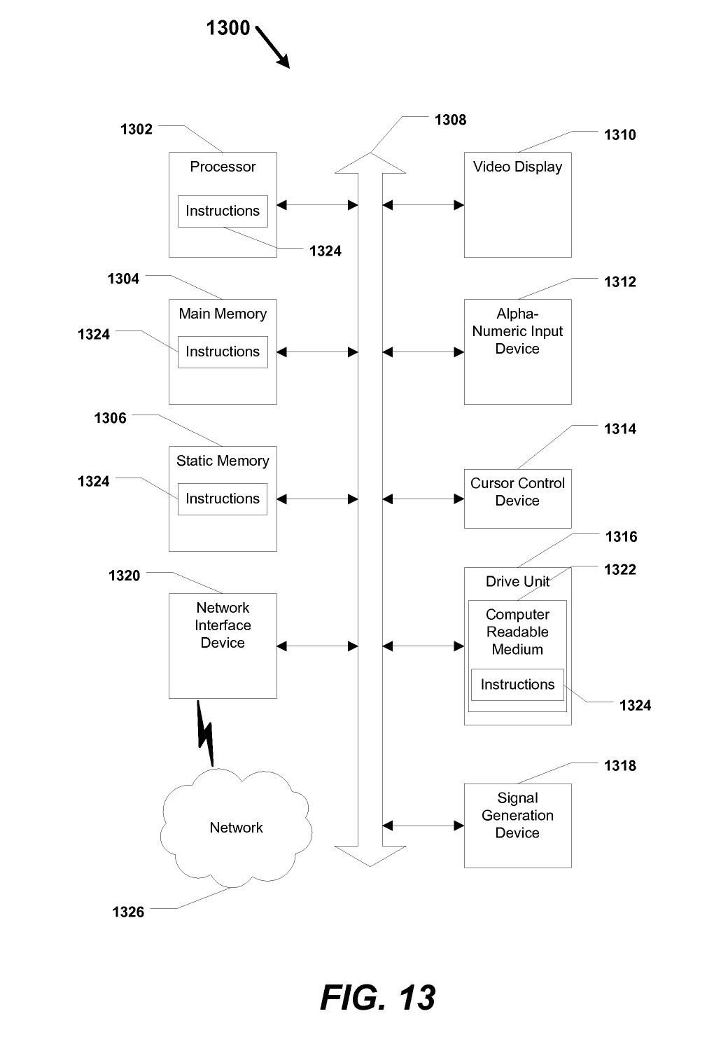

Referring to FIG. 13, an illustrative embodiment of a general computer system is shown and is designated 1300. The computer system 1300 can include a set of instructions that can be executed to cause the computer system 1300 to perform any one or more of the methods or computer-based functions disclosed herein. For example, the computer system 1300 may include instructions that are executable to perform the methods discussed with respect to FIGS. 11 and 12. In a particular embodiment, the computer system 1300 includes instructions to implement the position-determining module 130 and the movement-detection module 132 shown in FIG. 1. In a particular embodiment, the computer system 1300 includes or is included within the media device 102 shown in FIG. 1. In a particular embodiment, the computer system 1300 includes or is included within a set top box, such as the set top box 202 shown in FIGS. 2 and 5-10 or the set top box 302 shown in FIG. 3. The computer system 1300 may be connected to other computer systems or peripheral devices via a network, such as the network 106 shown in FIG. 1. Additionally, the computer system 1300 may include or be included within other computing devices.

As illustrated in FIG. 13, the computer system 1300 may include a processor 1302, e.g., a central processing unit (CPU), a graphics processing unit (GPU), or both. Moreover, the computer system 1300 can include a main memory 1304 and a static memory 1306 that can communicate with each other via a bus 1308. As shown, the computer system 1300 may further include a video display unit 1310, such as a liquid crystal display (LCD), a projection television display, a flat panel display, a plasma display, or a solid state display. Additionally, the computer system 1300 may include an input device 1312, such as a remote control device having a wireless keypad, a keyboard, a microphone coupled to a speech recognition engine, a camera such as a video camera or still camera, or a cursor control device 1314, such as a mouse device. The computer system 1300 can also include a disk drive unit 1316, a signal generation device 1318, such as a speaker, and a network interface device 1320. The network interface 1320 enables the computer system 1300 to communicate with other systems via a network 1326. For example, in particular embodiments the computer system 1300 includes or is included within a set top box. The network interface 1320 may enable the set top box to communicate with a media server, such as the media server 104 shown in FIG. 1, and receive media content to display on a display screen.

In a particular embodiment, as depicted in FIG. 13, the disk drive unit 1316 may include a computer-readable medium 1322 in which one or more sets of instructions 1324, e.g. software, can be embedded. For example, one or more modules, such as the position-determining module 130 or the movement-detection module 132 shown in FIG. 1 also can be embedded in the computer-readable medium 1322. Further, the instructions 1324 may embody one or more of the methods, such as the methods discussed with respect to FIGS. 11 and 12, or logic as described herein. In a particular embodiment, the instructions 1324 may reside completely, or at least partially, within the main memory 1304, the static memory 1306, and/or within the processor 1302 during execution by the computer system 1300. The main memory 1304 and the processor 1302 also may include computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations, or combinations thereof.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing or encoding a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an email or other self-contained information archive or set of archives may be considered equivalent to a tangible storage medium. Accordingly, the disclosure is considered to include any one or more of a computer-readable medium or other equivalents and successor media, in which data or instructions may be stored.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above-disclosed subject matter is to be considered illustrative, and not restrictive, and the appended claims are intended to cover all modifications, enhancements, and other embodiments, that fall within the true scope of the present disclosure. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method comprising:
determining a position on a display screen pointed to by a controller;
detecting a movement of the controller that changes a distance between the controller and the display screen; and
modifying a display presented by the display screen by performing a zoom operation related to the determined position on the display screen, wherein a change in the display based on the zoom operation is determined based on an amount the distance between the controller and the display screen is changed.

2. The method of claim 1, further comprising calibrating positions on the display screen with regard to positions of the controller.

3. The method of claim 1, further comprising receiving a toggle status from the controller, wherein the position on the display screen is determined when the received toggle status has a first value.

4. The method of claim 1, further comprising receiving a toggle status from the controller, wherein the movement of the controller that changes a distance between the controller and the display screen is determined when the received toggle status has a second value.

5. The method of claim 3, wherein the modified display presented by the display screen comprises a portion of an image, and wherein determining the position on the display screen pointed to by the controller comprises selecting the portion of the image presented by the display screen.

6. The method of claim 1, wherein determining the position on the display screen pointed to by the controller includes detecting positions of a first LED module and a second LED module relative to a detector along an x-axis and a y-axis substantially parallel to the display screen, wherein the x-axis is perpendicular to the y-axis.

7. The method of claim 1, wherein detecting the movement of the controller that changes a distance between the controller and the display screen comprises comparing a detected first position of a first LED module and a second LED module relative to a detector at a first time before the movement, and a detected second position of the first LED module and the second LED module relative to the detector at a second time after the movement, and determining based on the first position and the second position the amount the distance is changed, wherein the first LED module and the second LED module are a predetermined distance from each other.

8. The method of claim 7, wherein the first LED module and the second LED module are located at the controller.

9. The method of claim 7, wherein the detector is located at the controller.

10. The method of claim 1, wherein the display screen presents media content received from a set top box.

11. The method of claim 1, wherein the method is performed at a set top box.

12. The method of claim 1, further comprising determining a focus region on the display screen based on the determined position on the display screen.

13. The method of claim 11, wherein the focus region is indicated by a pointer displayed on the display screen.

14. The method of claim 11, wherein the focus region comprises a highlighted image of a plurality of images displayed on the display screen.

15. The method of claim 14, wherein the zoom operation enlarges the highlighted image.

16. The method of claim 11, wherein the focus region comprises a highlighted rectangular region on the display screen and wherein the zoom operation enlarges the highlighted rectangular region on the display screen.

17. The method of claim 16, wherein the display screen has a rectangular shape having a particular aspect ratio and wherein the highlighted rectangular region has an aspect ratio substantially the same as the particular aspect ratio of the display screen.

18. The method of claim 1, wherein the display presented by the display screen comprises a first collection of selectable images prior to the zoom operation and wherein the display presented by the display screen comprises a second collection of selectable images after the zoom operation.

19. The method of claim 18, further comprising retrieving the first collection of selectable images and the second collection of selectable images from an image library.

20. The method of claim 1, wherein the display presented by the display screen comprising a first page of a sequence of pages and wherein the display presented by the display screen comprises a second page of the sequence of pages after the zoom operation.

21. A method comprising:
receiving a position on a display screen from a controller;
receiving from the controller an amount a distance between the controller and the display screen has changed; and
modifying a display presented by the display screen by performing a zoom operation related to the position on the display screen, wherein a change in the display based on the zoom operation is determined based on the amount the distance between the controller and the display screen has changed.

22. A computer-readable storage medium comprising computer-executable instructions that, when executed, cause a processor to:
determine a position on a display screen pointed to by a controller;
detect a movement of the controller that changes a distance between the controller and the display screen; and
modify a display presented by the display screen by performing a zoom operation related to the determined position on the display screen, wherein a change in the display based on the zoom operation is determined based on an amount the distance between the controller and the display screen is changed.

23. The computer-readable storage medium of claim 22, wherein determining the position on the display screen pointed to by the controller includes detecting positions of a first LED module and a second LED module relative to a detector along an x-axis and a y-axis substantially parallel to the display screen, wherein the x-axis is perpendicular to the y-axis.

24. The computer-readable storage medium of claim 23, further comprising computer-executable instructions that, when executed, cause the processor to calibrate positions on the display screen with regard to positions of the first LED module and the second LED module along the x-axis and the y-axis.

25. A system comprising:
a detector to detect a position of a first LED module and a second LED module relative to the detector, wherein the first LED module and the second LED module are located at a controller and are a predetermined distance from each other;
a position-determining module to determine a position on a display screen pointed to by the controller based on the position of the first LED module and the position of the second LED module;
a movement-detection module to detect a movement of the controller that changes a distance between the controller and the display screen; and
a display module to modify a display presented by the display screen by performing a zoom operation related to the determined position on the display screen, wherein a change in the display based on the zoom operation is determined based on an amount the distance between the controller and the display screen is changed.
